(19) United States
(12) Patent Application Publication
(10) Pub. No.: US 2025/0067866 A1
(43) Pub. Date: Feb. 27, 2025

(54) COMMUNICATION CONTROL DEVICE, COMMUNICATION CONTROL METHOD, AND STORAGE MEDIUM

(71) Applicant: DENSO CORPORATION, Kariya-city (JP)

(72) Inventor: Tetsuya AOYAMA, Kariya-city (JP)

(21) Appl. No.: 18/942,175

(22) Filed: Nov. 8, 2024

Related U.S. Application Data
(63) Continuation of application No. PCT/JP2023/014579, filed on Apr. 10, 2023.

(30) Foreign Application Priority Data
May 12, 2022 (JP) 2022-079069

(51) Int. Cl. G01S 13/93; G01S 7/40

(52) U.S. Cl. CPC G01S 13/93; G01S 7/40

(57) ABSTRACT

The communication control device is configured to control communication between a central unit and a sensor unit in a sensor system having the central unit as a master device and the sensor unit as a slave device. The communication control device has: a sensitivity acquiring unit, that acquires a sensitivity status of the sensor unit during a detection operation in the sensor unit, the sensitivity status being defined as either a high sensitivity status or a low sensitivity status that is lower than the high sensitivity status, and a communication control unit that communicates special communication signals when the sensitivity acquiring unit acquires the low sensitivity status, the special communication signals being communication signals that are noise sources in the detection operation.

### CROSS-REFERENCING OF RELATED APPLICATION

The present application is a continuation application of International Application No. PCT/JP2023/014579, filed on Apr. 10, 2023, which claims priority to Japanese Patent Application No. 2022-079069, filed on May 12, 2022. The contents of these applications are incorporated herein by reference in their entirety.

### BACKGROUND

### 1. Technical Field

This disclosure relates to a communication control device, a communication control method, and a storage medium storing a communication control program for controlling communication between a central unit and a sensor unit in a sensor system having a central unit as a master device and a sensor unit as a slave device.

### 2. Related Art

JP6894043B discloses a method for operating a sensor device in a vehicle based on the DSI protocol. DSI stands for Distributed System Interface. A sensor device has a central unit, which is a master device, and a plurality of sensor units, each of which is a slave device controlled by the master device. The central unit and each of the plurality of sensor units are connected to a bus cable. Communication between the central unit and each of the sensor units is performed via the bus cable.

### SUMMARY

The communication control device is configured to control communication between a central unit and a sensor unit in a sensor system having the central unit as a master device and the sensor unit as a slave device. According to one aspect of the present disclosure, the communication control device has: a sensitivity acquiring unit, that acquires a sensitivity status of the sensor unit during a detection operation in the sensor unit, the sensitivity status being defined as either a high sensitivity status or a low sensitivity status that is lower than the high sensitivity status, and a communication control unit that communicates special communication signals when the sensitivity acquiring unit acquires the low sensitivity status, the special communication signals being communication signals that are noise sources in the detection operation.

According to another aspect of the present disclosure is the communication control method for controlling communication between a central unit and a sensor unit in a sensor system, the sensor system having the central unit as a master device and the sensor unit as a slave device. The communication control method has: acquiring a sensitivity status of the sensor unit during a detection operation in the sensor unit, the sensitivity status being defined as either a high sensitivity status or a low sensitivity status that is lower than the high sensitivity status, and communicating special communication signals when the low sensitivity status is acquired, the special communication signals being communication signals that are noise sources in the detection operation.

According to still another aspect of the present disclosure is the computer-readable non-transitory storage medium storing a communication control program to be executed by a communication control device that controls communication between a central unit and a sensor unit in a sensor system, the sensor system having the central unit as a master device and the sensor unit as a slave device. The communication control program causes the communication control device to perform: acquiring a sensitivity status of the sensor unit during a detection operation in the sensor unit, the sensitivity status being defined as either a high sensitivity status or a low sensitivity status that is lower than the high sensitivity status, and communicating special communication signals when the low sensitivity status is acquired, the special communication signals being communication signals that are noise sources in the detection operation.

### BRIEF DESCRIPTION OF THE DRAWINGS

FIG. 1 is a schematic diagram of a vehicle equipped with a sensor system including the communication control device of the embodiment.

FIG. 2 is a block diagram showing the schematic functional configuration of the sensor system shown in FIG. 1.

FIG. 3 is a block diagram showing the schematic functional configuration of the communication control device in the sensor system shown in FIG. 2.

FIG. 4 is a time chart showing an example of signal communication in the sensor system shown in FIG. 2.

FIG. 5 is a flowchart showing a specific example of one operation in the sensor system shown in FIG. 2.

### DETAILED DESCRIPTION OF THE PREFERRED EMBODIMENTS

Noise can occur during communication between the central unit and each sensor unit. This noise can cause false detection in the sensor units. On the other hand, if communication between the central unit and the sensor units is not performed at all during the detection operation in the sensor units, the detection performance will be limited due to the longer detection operation cycle. The present disclosure was made in view of the above-mentioned problems. The present disclosure provides, for example, a technology that enables communication that becomes a noise source to be performed during detection operations in a sensor unit and enables good avoidance of false detections in the sensor unit.

In the various parts of this application documents, each element may be marked with a parenthesized reference code. However, such reference codes merely indicate an example of the correspondence between the element and the specific means described in the embodiments to be described later. Therefore, the present disclosure is not limited in any way by the description of the above reference codes.

The following is a description of an embodiment of the present disclosure based on the drawings. The descriptions in each drawing and the corresponding descriptions of device configurations and their functions or operations described below are simplified for the purpose of briefly explaining the contents of this disclosure, and do not limit the contents of this disclosure in any way. Therefore, it goes without saying that the exemplary configurations shown in the figures do not necessarily correspond to the specific configurations manufactured and sold. In other words, it goes without saying that the present disclosure should not be interpreted as limited by the descriptions in each drawing or the descriptions of the device configuration and its functions or operations described below in response thereto, unless the applicant explicitly limits them by the course of filing this application or otherwise. Therefore, various variations can be applied to the embodiments described below. However, if variations are inserted in the middle of a series of explanations of the embodiments, the understanding of the embodiments may be hindered. For this reason, the variant examples are described collectively after the explanation of the embodiment.

### Overall Configuration of the Sensor System

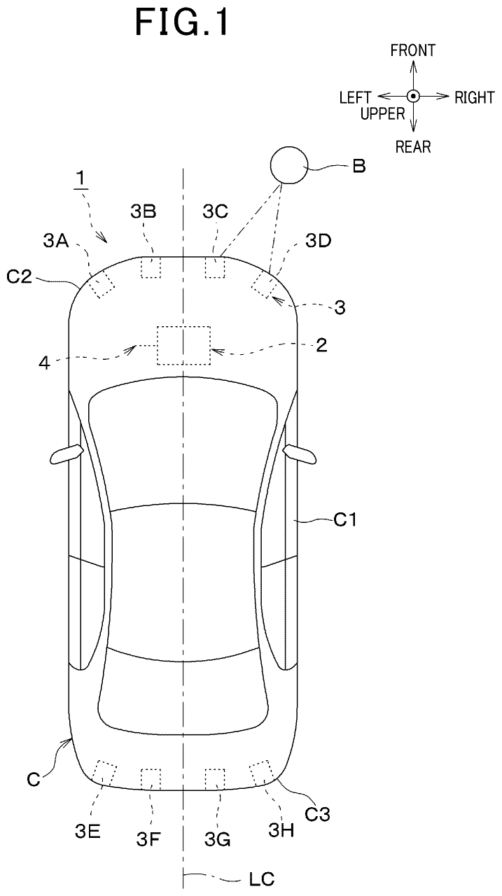

Referring to FIG. 1, the sensor system 1 of this embodiment is an in-vehicle system that performs various functions when installed in a vehicle C, which is a mobile object. The vehicle C is a so-called four-wheeled vehicle that runs on the ground, i.e., on the road. The vehicle C has a box-like body C1 that is rectangular in a plan view. The shape of each part of the vehicle C in plain view refers to the shape of the vehicle C when the vehicle C is stably placed on a horizontal surface for driving and the part is viewed with a line of sight in the same direction as the direction of gravity action. The vehicle C in which the sensor system 1 is mounted is hereinafter referred to as “own vehicle”.

Hereafter, the virtual straight line that passes through the center of the vehicle in the vehicle width direction and is parallel to the overall length direction of the vehicle in plain view is referred to as the vehicle width center line LC. The vehicle centerline LC is also referred to as the vehicle centerline. The vehicle length direction is orthogonal to the vehicle width direction and orthogonal to the vehicle height direction and is also referred to as the vehicle length direction. The vehicle height direction defines the height of the vehicle and is parallel to the direction of gravity action when the vehicle is placed stably on a horizontal surface for driving. In addition, “front,” “rear,” “left,” “right,” and “upper” are defined as indicated by arrows in FIG. 1. In other words, the overall vehicle length direction is synonymous with the front-back direction. The vehicle width direction is synonymous with the left-right direction.

The sensor system 1 has a central unit 2 as a master device and a sensor unit 3 as a slave device. Multiple sensor units 3 may be provided for one sensor system 1. In this embodiment, the sensor system 1 is a communication system conforming to the DSI3 standard. The central unit 2 and the sensor unit 3 send and receive information or signals to and from each other via a communication line 4. The central unit 2 and a plurality of sensor units 3 are connected in any connection configuration, such as bus, daisy chain, star, etc. The sensor system 1 can switch between command response mode and periodic data collection mode. CRM mode stands for “Command and Response Mode” and PDCM mode stands for “Periodic Data Collection Mode”. PDCM mode is an example of a second communication mode that provides one-way communication from the sensor unit 3 to the central unit 2. When a trigger signal is received, the system switches from the first communication mode to the second communication mode.

In this embodiment, the central unit 2 is an object detection ECU that detects an object B existing around the own vehicle using the sensor unit 3, which is an object detection sensor. ECU stands for Electronic Control Unit. The sensor unit 3 is mounted to the own vehicle and receives a reflected wave by the object B of the probe wave transmitted toward the outside of the own vehicle. The sensor unit 3 is a so-called distance-measuring sensor and acquires distance information. The distance information may be the propagation time between the transmission of the probe wave and the reception of the reflected wave, or the distance measured, which is calculated based on the propagation time. The distance is an estimated distance between the sensor unit 3 and object B.

The sensor unit 3 may be, for example, an ultrasonic sensor. The sensor unit 3 detects the presence or absence of object B and the distance to object B by receiving the reflected wave by object B of the probe wave, which is an ultrasonic wave transmitted toward the outside. In this embodiment, the sensor unit 3 has an integrated transmitter/receiver configuration. In other words, the sensor unit 3 has a function as a transmitter that transmits a probe wave to the outside of the own vehicle and a receiver that receives a received wave including the reflected wave by the object B of the probe wave.

A first front sensor 3A, a second front sensor 3B, a third front sensor 3C, and a fourth front sensor 3D are mounted to the front bumper C2 at the front portion in the vehicle body C1 of the own vehicle. Similarly, a first rear sensor 3E, a second rear sensor 3F, a third rear sensor 3G, and a fourth rear sensor 3H are mounted to the rear bumper C3 at the rear of the vehicle body C1 of the own vehicle. Each of these configurations corresponds to sensor unit 3.

The first front sensor 3A is mounted near the left end in the front bumper C2 and transmits a transmission wave toward the left front of the vehicle. The second front sensor 3B is mounted between the first front sensor 3A and the vehicle width center line LC in the vehicle width direction and transmits a transmission wave toward the front of the vehicle. The third front sensor 3C is mounted symmetrically with the second front sensor 3B across the vehicle width center line LC. The third front sensor 3C is mounted between the vehicle width center line LC and the fourth front sensor 3D with respect to the vehicle width direction. The fourth front sensor 3D, which transmits a transmission wave toward the front of the vehicle shortly, is mounted symmetrically with the first front sensor 3A across the vehicle width center line LC. The fourth front sensor 3D is mounted near the right end in the front bumper C2 and transmits a transmission wave toward the right front of the vehicle.

The first rear sensor 3E is mounted near the left end of the rear bumper C3 and transmits a transmission wave toward the left rear of the vehicle. The second rear sensor 3F is mounted between the first rear sensor 3E and the vehicle width center line LC in the vehicle width direction and transmits a transmission wave toward the short rear of the vehicle. The third rear sensor 3G is mounted symmetrically with the second rear sensor 3F across the vehicle width center line LC. The third rear sensor 3G is mounted between the vehicle width center line LC and the fourth rear sensor 3H with respect to the vehicle width direction and transmits a transmission wave toward the rear of the vehicle. The fourth rear sensor 3H is mounted symmetrically with the first rear sensor 3E across the vehicle width center line LC. The fourth rear sensor 3H is mounted near the right end in the rear bumper C3 and transmits a transmission wave toward the right rear of the vehicle.

### Central Unit

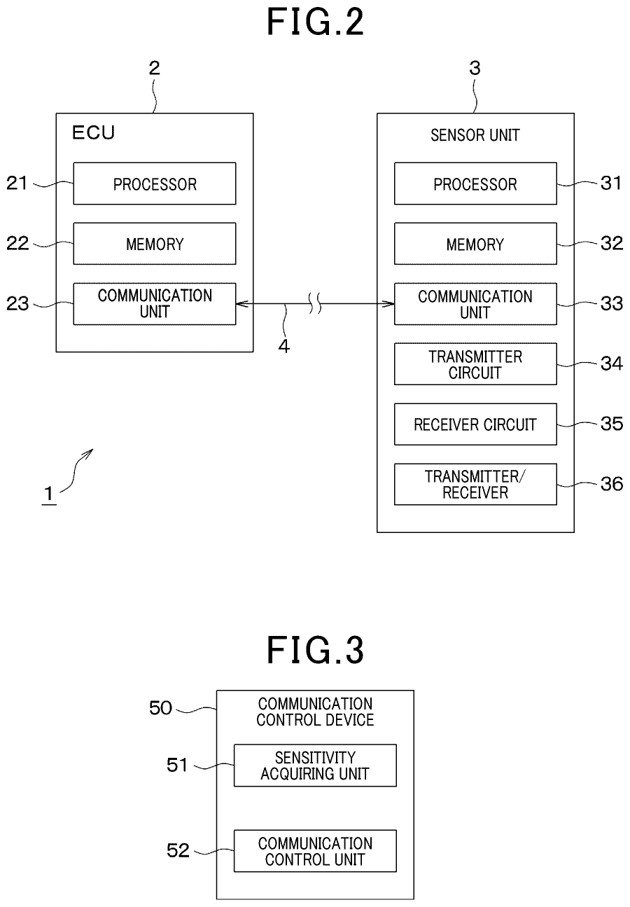

The central unit 2 is an in-vehicle microcomputer with a processor and memory. Referring to FIG. 2, the central unit 2 has a master-side processor 21, a master-side memory 22, and a master-side communication unit 23.

The master-side processor 21 performs various control operations by reading and executing programs stored in the master-side memory 22. The master-side memory 22 includes at least ROM or nonvolatile rewritable memory among various non-transitory substantive storage medium such as ROM, RAM, nonvolatile rewritable memory, etc. Nonvolatile rewritable memory allows information to be rewritten while power is on, while nonvolatile rewritable memory holds information nonrewritable while power is off. The nonvolatile rewritable memory is, for example, flash memory. In addition to the program described above, the master-side memory 22 stores various parameters such as initial values required for program execution. The master-side communication unit 23 is a communication interface connected to the communication line 4. The master-side communication unit 23 performs communication based on the DSI3 protocol with the sensor unit 3 under the control of the master-side processor 21.

### Sensor Unit

Referring to FIG. 2, the sensor unit 3 has a sensor-side processor 31, a sensor-side memory 32, and a sensor-side communication unit 33. The sensor-side processor 31 reads and executes the program stored in the sensor-side memory 32 to control the overall operation of the sensor unit 3. The sensor-side memory 32 includes at least ROM or nonvolatile rewritable memory among various non-transitory substantive storage media such as ROM, RAM, nonvolatile rewritable memory, and the like. In addition to the program described above, the sensor-side memory 32 stores various parameters such as initial values required for program execution. The sensor-side communication unit 33 is a communication interface connected to the communication line 4 and performs communication based on the DSI3 protocol with the central unit 2 under the control of the sensor-side processor 31.

The sensor unit 3 also has a transmitter circuit 34, a receiver circuit 35, and a transmitter/receiver 36. The transmitter circuit 34 applies a drive signal to the transmitter/receiver 36 to generate probe wave at the transmitter/receiver 36 in a transmission operation to transmit probe waves to the outside. The receiving circuit 35 performs various signal processing, such as amplification, filtering, etc., on the received signal generated by the transmitter/receiver 36 according to the reception status of the reflected wave in the receiving operation to receive the reflected wave. The transmitter/receiver 36 generates a probe wave by being applied the drive signal from the transmitter circuit 34 in the transmitting operation. The transmitter/receiver 36 generates a receiving signal in response to the reception of the reflected wave in the receiving operation. In this embodiment, the transmitter/receiver 36 is a so-called resonant ultrasonic microphone with a built-in electrical-mechanical energy conversion clement such as a piezoelectric element.

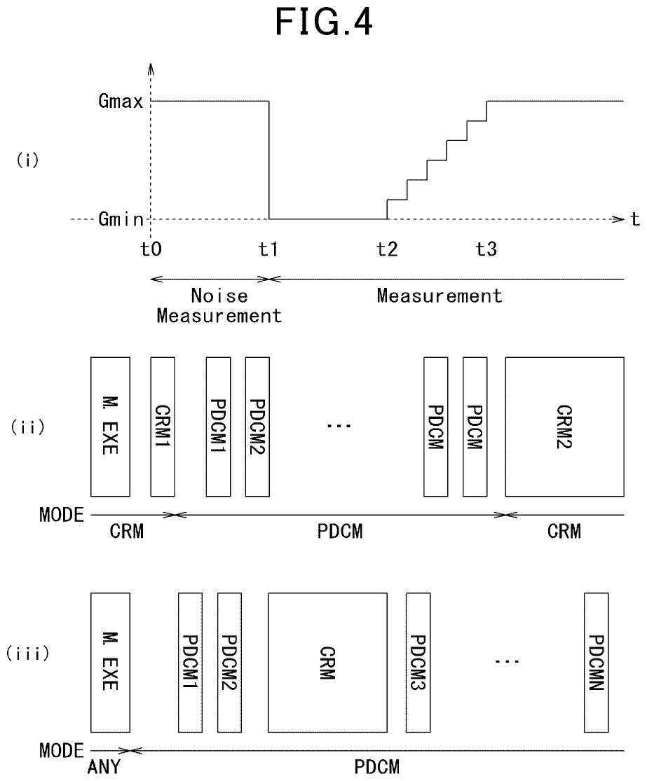

The sensitivity of the sensor unit 3 is set to change with the passage of time during the detection operation. For example, the sensor unit 3 may perform STC in which the sensitivity changes with the passage of time from the transmission of the probe wave from the transmitter/receiver 36. STC stands for Sensitivity Time Control. For example, the sensor-side processor 31 may change the gain in the amplifier provided in the receiver circuit 35 over time according to the relationship between time and gain shown in (i) in FIG. 4, which is stored in the sensor-side memory 32.

### Communication Controller

FIG. 3 shows the functional configuration of the communication control device 50, which is realized by execution of a program in at least one of the master-side processor 21 and the sensor-side processor 31 shown in FIG. 2. The communication control device 50 controls communication between the central unit 2 and the sensor unit 3. The communication control device 50 has a sensitivity acquiring unit 51 and a communication control unit 52.

The sensitivity acquiring unit 51 acquires the sensitivity status of the sensor unit 3 during detection operation. The sensitivity status may be defined either a predetermined high sensitivity status or a low sensitivity status that is lower than the high sensitivity status. For example, the sensitivity acquiring unit 51 recognizes a low sensitivity interval, which is a time period in which the sensitivity is in the low-sensitivity status. The high sensitivity status and the low sensitivity status are described below. The communication control unit 52 controls the communication timing of communication signals between the central unit 2 and the sensor unit 3. The communication control unit 52 communicates special communication signals, which are communication signals that is a noise source in the detection operation by the sensor unit 3, when the sensitivity status is in the low sensitivity status. The communication control unit 52 communicates non-special communication signals, which are different from the special communication signals, when the sensitivity status is either the high communication status or the low communication status.

The special communication signals include a command signal sent from the central unit 2 to the sensor unit 3 and a response signal sent from the sensor unit 3 to the central unit 2 in response to the command signal. Non-specialty communication signals include detection result signals corresponding to the results of detection operations by sensor unit 3. In other words, the special communication signals are communication signals transmitted and received in the CRM mode, which is an example of the first communication mode (i.e., CRM signals). On the other hand, the non-special communication signals are communication signals transmitted and received in the PDCM mode, which is an example of the second communication mode (i.e., PDCM signal).

### Overview of Operation

The following is an overview of an operation of the device configuration, method, and program of this embodiment, using the time chart shown in FIG. 4. In FIG. 4, (i) shows the time variation of the gain sensitivity status in the sensor unit 3, (ii) shows an example of signal communications in a comparative example, and (iii) shows an example of signal communications in this embodiment. In the figure, G on the vertical axis in (i) stands for gain, and t on the horizontal axis indicates time. In (ii) and (iii), “M.EXE” stands for Measurement Execute. A Measurement Execute command is a detection start signal to start the detection operation in sensor unit 3. “MODE” indicates the communication mode. Since the time lapse on the horizontal axis in (i) corresponds to the communication timing and communication mode of each signal in (ii) and (iii), (i) through (iii) are shown side by side in FIG. 4.

The detection operation in sensor unit 3 starts when central unit 2 sends a detection start signal, which is a CRM signal, and sensor unit 3 receives the detection start signal. In the detection operation, the sensor unit 3 causes the transmitter/receiver 36 to transmit the probe wave and performs the receiving operation of the reflected wave by the object B of the probe wave. First, the sensor unit 3 performs the measurement of electrical noise and acoustic noise in the sensor unit 3 during the period from the start time 10 of the detection operation to the time t1 when the predetermined time elapses. During the noise measurement from time t0 to t1, the sensitivity, or gain, is set to the highest value Gmax. Next, after time t1, when the noise measurement is completed, the sensor unit 3 performs the object detection operation. From time t1 to t2, the transmitting operation of the probe wave is performed, and the waiting time from the end of the transmitting operation to the reverberation convergence is included in this period. During this period, the sensitivity, or gain, is set to the lowest value, Gmin. After time t2, the receiving operation is performed. Here, during the period from time t2 to t3, the sensitivity, or gain, gradually increases from the minimum value Gmin to the maximum value Gmax and is maintained at the maximum value Gmax for a predetermined period after time t3. This increases the sensitivity to the reflected wave from the object B. The sensor unit 3 then transmits the PDCM signal corresponding to the reception result of the reflected wave, i.e., the detection result of object B, to the central unit 2.

The comparative example shown in (ii) in FIG. 4 shows the case where this embodiment is not applied. Here, the Measurement Execute command, or the detection start signal, is the CRM signal. Therefore, as shown in the time chart in (ii) in FIG. 4, in the comparative example, the communication mode must have already been switched from the PDCM mode to the CRM mode at the time the detection start signal is transmitted and received. On the other hand, to receive the PDCM signal from the sensor unit 3, the communication mode must have been switched to the PDCM mode. Therefore, the central unit 2 sends a mode change signal to the sensor unit 3 to change the communication mode from the CRM mode to the PDCM mode, indicated as “CRM1” in the figure. This causes the communication mode to be switched from the CRM mode to the PDCM mode.

In the PDCM mode, the PDCM signals transmitted from the sensor unit 3 to the central unit 2 and received by the central unit 2 are assigned sequential codes in the chronological order of transmission and reception, such as PDCM1 signal, PDCM2 signal, PDCM3 signal, etc. A BRC trigger signal, which is the trigger signal sent from the central unit 2 to the sensor unit 3 for the transmission of the PDCM signal, is omitted from the figure to avoid complication of the figure. BRC stands for Broadcast Read Command. To change the conditions of the detection operation in sensor unit 3 (e.g., frequency of probe wave, transmission/reception period, etc.), it is necessary to send a detection condition setting signal from the central unit 2 to the sensor unit 3. The detection condition setting signal is the CRM signal to set the conditions of detection operation in sensor unit 3. Therefore, the central unit 2 sends the CRM signal shown as “CRM2” in the figure to the sensor unit 3. The CRM2 signal includes a mode change signal to change the communication mode from the PDCM mode to the CRM mode and the detection condition setting signal that becomes effective after the mode change signal is sent and received.

Noise can occur during communication between the central unit 2 as the master device and the sensor unit 3 as the slave device. Here, the communication that can be a noise source is mainly the communication of signals in the CRM mode, including the transmission of commands from the central unit 2 to the sensor unit 3 and their responses from the sensor unit 3 to the central unit 2. Noise can produce false detections in sensor unit 3. Specifically, as shown in (ii) in FIG. 4, if the CRM2 signal, which is a communication signal that is a noise source, is transmitted and received in a high sensitivity status with high gain, there is concern about the occurrence of false detection due to the noise. On the other hand, if communication between the central unit 2 and the sensor unit 3 is not performed at all during the detection operation of the sensor unit 3, the detection performance will be limited due to the longer detection operation cycle.

Therefore, as shown in (iii) in FIG. 4, this embodiment communicates the CRM signal, which is a communication signal that is a noise source in the detection operation by sensor unit 3, only when it is in a low sensitivity status. Here, for example, the “high sensitivity status” may be a state in which the gain is set above a predetermined gain threshold, and the “low sensitivity status” may be a state in which the gain is set below the gain threshold. Or, for example, the “high sensitivity status” may be a state in which the gain is at the highest value Gmax, and the “low sensitivity status” may be a state in which the gain is below the highest value Gmax. In this regard, the sensitivity acquiring unit 51 can, for example, may recognize the timing of the occurrence of the low sensitivity section based on the transmission/reception time of the Measurement Execute command. The communication control unit 52 then sets the timing of sending and receiving CRM signals within the low-sensitivity section. Specifically, for example, the communication control unit 52 may communicate the CRM signal including the detection condition setting signal like the CRM2 signal in the comparison example in (ii) in FIG. 4 between time t1 and t2, i.e., during the low sensitivity section when the gain is set to the lowest value Gmin. This makes it possible to avoid the false detection in the sensor unit 3 even if the CRM signal, which is a noise source, is communicated during the detection operation in the sensor unit 3, and to improve the short-range detection performance by shortening the detection operation cycle.

In this embodiment, the PDCM signal, which is a communication signal that is hardly a noise source in the detection operation, is transmitted and received regardless of the sensitivity status. Therefore, the PDCM signals can be transmitted and received not only in the low-sensitivity status but also in the high-sensitivity status. This makes it possible to further improve short-range detection performance by shortening the detection operation cycle.

When the CRM signal is received during the PDCM mode, this embodiment preforms the processing corresponding to the received CRM signal. As shown in (iii) in FIG. 4, this makes it possible to send and receive the detection start signals regardless of the communication mode. According to this, it is not necessary that the communication mode is switched from the PDCM mode to the CRM mode at the time of sending and receiving the detection start signal. Also, the communication mode does not need to be switched from the PDCM mode to the CRM mode when sending and receiving the CRM signals including the detection condition setting signals in the low sensitivity status during the detection operation of sensor unit 3. Thus, according to this embodiment, it is possible to suppress the communication volume by reducing the number of times the mode change signal is sent and received to switch the communication mode from the PDCM mode to the CRM mode, and it is also possible to further improve the short-range detection performance by shortening the detection operation cycle.

The PDCM signals are assigned sequential codes in the chronological order of transmission and reception during a series of detection operations, i.e., from the time of transmission and reception of the Measurement Execute command to the time of transmission and reception of the Measurement Stop command. The Measurement Stop command is a detection end signal to terminate the detection operation in sensor unit 3. This system resets the code to be assigned next time to the initial value by sending and receiving a reset signal, which is the CRM signal, and does not reset the code to the initial value even if the CRM signal different from the reset signal is sent and received. The “reset signal” is either the detection start signal or the detection end signal. As shown in (iii) in FIG. 4, if the CRM signal is sent or received immediately after the PDCM2 signal, but the CRM signal is not the reset signal, the PDCM signal immediately after that is the PDCM3 signal. As a result, even if the CRM signal is transmitted and received in a low-sensitivity status during a series of the detection operations, the sign of the sequential number assigned to the PDCM signal is avoided from being reset inadvertently in the process. Therefore, according to this embodiment, it is possible for the central unit 2 to obtain data from the multiple sensor units 3 in a good manner.

This embodiment switches from the CRM mode to the PDCM mode not only when a mode change signal is sent or received, but also when the detection start signal or the detection condition setting signal is sent or received. This makes it possible to suppress the communication volume by reducing the number of times mode change signals are sent and received, and it also makes it possible to further improve the short-range detection performance by shortening the detection operation cycle.

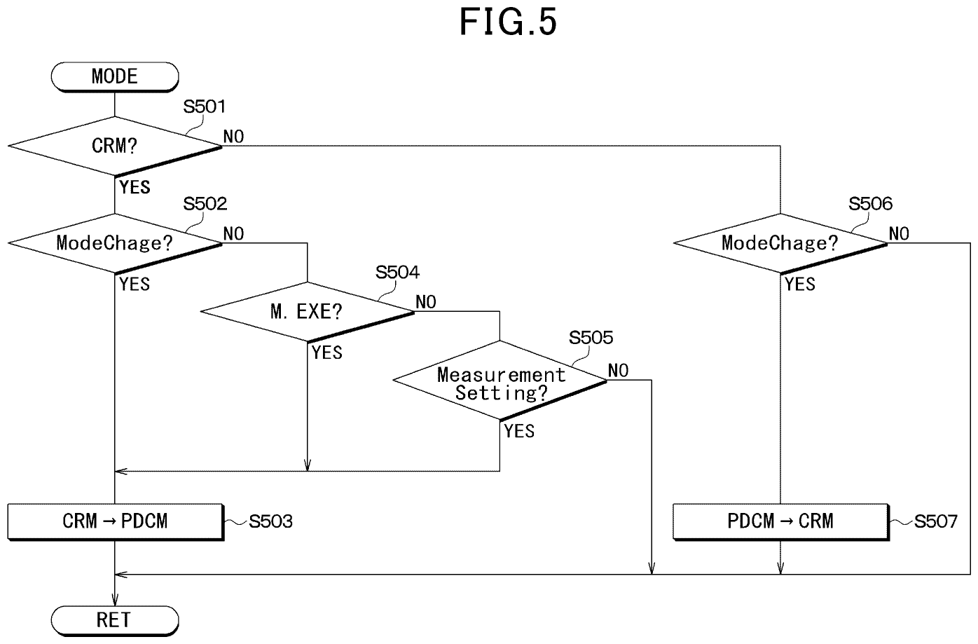

FIG. 5 is a flowchart showing the process of switching the communication mode. “S” stands for step. The flowchart shown in FIG. 5 is used to explain the process related to switching the communication modes. First, at step 501, the communication control unit 52 determines whether the current communication mode is the CRM mode.

When the current communication mode is the CRM mode (i.e., step 501=YES), the communication control unit 52 performs the processing of step 502. In step 502, the communication control unit 52 determines whether the Mode Change command, i.e., the mode change signal, has been sent and received. When the mode change signal has been sent and received (i.e., step 502=YES), the communication control unit 52 performs the processing of step 503 to temporarily terminate the processing related to switching the communication mode. In step 503, the communication control unit 52 switches the communication mode from the CRM mode to the PDCM mode. When the mode change signal has not been sent and received (i.e., step 502=NO), the communication control unit 52 performs the process of step 504. At step 504, the communication control unit 52 determines whether the Measurement Execute command, i.e., the detection start signal, has been sent and received. When the detection start signal has been sent and received (i.e., step 504=YES), the communication control unit 52 performs the processing of step 503 to temporarily terminate the processing related to switching the communication mode. When the detection start signal has not been sent and received (i.e., step 504=NO), the communication control unit 52 performs the processing of step 505. In step 505, the communication control unit 52 determines whether the Measurement Setting command, i.e., a detection condition setting signal, has been sent and received. When the detection condition setting signal has been sent and received (i.e., step 505=YES), the communication control unit 52 performs the processing of step 503 to temporarily terminate the processing related to switching the communication mode. On the other hand, when the detection condition setting signal has not been sent and received (i.e., step 505=NO), the communication control unit 52 skips processing of step 503 and terminates processing related to communication mode switching once and for all.

When the current communication mode is the PDCM mode (i.e., step 501=NO), the communication control unit 52 performs the processing of step 506. In step 506, the communication control unit 52 determines whether the Mode Change command, i.e., the mode change signal, has been sent and received. When the mode change signal has been sent and received (i.e., step 506=YES), the communication control unit 52 performs the processing of step 507 to temporarily terminate the processing related to switching the communication mode. At step 507, the communication control unit 52 switches the communication mode from the PDCM mode to the CRM mode. When the mode change signal has not been sent and received (i.e., step 506=NO), the communication control unit 52 skips the processing of step 507 and terminates the processing related to the communication mode switchover once and for all.

The present disclosure is not limited to the above embodiment. Therefore, any modifications to the above embodiment are possible. Representative variations are described below. In the following description of the variations, the differences from the above embodiment are mainly explained. In the above embodiments and variations, the same symbols are attached to the parts that are identical or equal to each other. Therefore, in the following description of the variations, the description in the above embodiment may be aptly applied to the components having the same symbols as those in the above embodiment, unless there is any technical inconsistency or special additional explanation.

The present disclosure is not limited to the specific device configuration shown in the above embodiment. The disclosure is not limited to the specific device configurations shown in the above embodiments.

All or part of the functional configuration realized by the master-side processor 21 and the master-side memory 22 in the central unit 2 can be replaced by digital circuits such as ASICs and FPGAs. FPGA stands for Field Programmable Gate Array. In other words, in the central unit 2, the in-vehicle microcomputer portion and the digital circuit portion can coexist. The same applies to the sensor unit 3.

Alternatively, the program can be downloaded or upgraded via V2X communication. V2X stands for Vehicle to X. Alternatively, the program can be downloaded or upgraded via terminal equipment at a manufacturing plant, maintenance store, dealership, etc. of the vehicle C. The program may be stored on a memory card, optical disk, magnetic disk, or the like.

Each of the above functional configurations and processes may be realized by a dedicated computer provided by configuring a processor and memory programmed to perform one or more functions embodied by the computer program. Alternatively, each of the above functional configurations and processing may be realized by a dedicated computer provided by configuring the processor with one or more dedicated hardware logic circuits. Alternatively, each of the above functional configurations and processing may be realized by one or more dedicated computers provided by a combination of a processor and memory programmed to perform one or more functions and a processor configured by one or more dedicated hardware logic circuits. The computer program may also be stored in a computer-readable non-transitory substantive storage medium as instructions to be executed by a computer. In other words, each of the above functional configurations and processes can be expressed as a computer program including procedures for realizing them, or as a non-transitory substantive storage medium storing the program.

Therefore, the sensitivity acquiring unit 51 and the communication control unit 52 shown in FIG. 3 are only functional configuration blocks set up for convenience to contribute to the understanding of the contents of this disclosure. Therefore, even if these functional configuration blocks are not actually realized in the central unit 2 and/or sensor unit 3 as routines or hardware, it is sufficient if the functions or processing prescribed in this disclosure are realized.

The connection method between the central unit 2 as the master device and the sensor unit 3 as the slave device is not limited to DSI but may also be PSI. PSI stands for Peripheral Sensor Interface. There is no limitation on the version of DSI or PSI, but it is suitable to use the latest version at the time of implementation, such as DSI3 or PSI5 at the time of filing of this application. Thus, the present disclosure is widely applicable to time division multiple access, or TDMA.

For example, three sensor units 3 may be mounted on each of the front bumper C2 and rear bumper C3. Or, for example, five or more sensor units 3 may be mounted on the front bumper C2 and/or rear bumper C3. Or, for example, the sensor units 3 may be mounted on the side of the vehicle body C1.

There are no limitations on the specific configuration or use of the sensor unit 3. That is, for example, the sensor unit 3 is not limited to a transmitter/receiver integrated type in which a single transmitter/receiver 36 performs the transmitting/receiving operation but may be configured with a transmitter/receiver 36 for transmission and a receiver 36 for reception separately installed in a single housing. In addition, one of the multiple sensor units 3 may be used for transmission and the other for reception. In this case, the sensor unit 3 for transmission and the sensor unit 3 for reception may be interchanged as necessary over time.

The sensor unit 3 is not limited to so-called ultrasonic sensors. For example, the sensor unit 3 may be a radar sensor. The sensor unit 3 is not limited to so-called distance measurement sensors. Specifically, for example, the sensor unit 3 may be a collision detection sensor in an airbag system.

The present disclosure is not limited to the specific modes of operation shown in the above embodiments. That is, for example, the manner in which the gain, or sensitivity, changes over time is not limited to the specific example shown in (i) in FIG. 4. Specifically, for example, the manner in which the gain increases between time t2 and t3 is not limited to the step-like manner shown in the figure but may be linear or curved. The sensitivity acquiring unit 51 may also be able to determine whether the sensitivity status at a particular processing timing by the processor is in a high-sensitivity status or a low-sensitivity status. In this case, the sensitivity acquiring unit 51 may be referred to as the “sensitivity determination unit.

The terms “more than” and “greater than” are interchangeable. Similarly, “less than” and “less than” are interchangeable. Similar concepts such as “acquiring,” “calculation,” “detection,” and “detection” are also interchangeable as long as they are not technically inconsistent or inconvenient.

It goes without saying that the elements comprising the above embodiments are not necessarily indispensable, except when expressly stated as being indispensable, or when they are clearly indispensable in principle. In addition, when numerical values of the number, amount, range, etc. of components are mentioned, this disclosure is not limited to such specific values, except when expressly stated as being particularly essential or when clearly limited to specific values in principle, etc. Similarly, when the shape, direction, positional relationship, etc. of a component, etc. is mentioned, the disclosure is not limited to that shape, direction, positional relationship, etc., except in cases where it is explicitly stated that it is particularly essential or limited to a specific shape, direction, positional relationship, etc. in principle.

Variations are also not limited to the above examples. For example, a plurality of variations may be combined with each other as long as they are not technically inconsistent. Furthermore, all or part of the above embodiments and all or part of the variations can be combined with each other as long as they are not technically inconsistent.

As is clear from the above description, the present disclosure includes at least the following aspects.

### Aspect 1-1

A communication control device (50) configured to control communication between a central unit (2) and a sensor unit (3) in a sensor system (1), the sensor system comprising the central unit as a master device and the sensor unit as a slave device, the communication control device (50) comprising:

a sensitivity acquiring unit (51), that acquires a sensitivity status of the sensor unit during a detection operation in the sensor unit, the sensitivity status being defined as either a high sensitivity status or a low sensitivity status that is lower than the high sensitivity status; and

a communication control unit (52) that communicates special communication signals when the sensitivity acquiring unit acquires the low sensitivity status, the special communication signals being communication signals that are noise sources in the detection operation.

### Aspect 1-2

In the case of aspect1-1, the sensitivity status changes with the passage of time during the detection operation.

### Aspect 1-3

In the aspect 1-1 or 1-2, the special communication signals include a command signal sent from the central unit to the sensor unit and a response signal sent from the sensor unit to the central unit in response to the command signal.

### Aspect 1-4

In any one of the aspects 1-1 to 1-3, the communication control unit communicates non-special communication signals different from the special communication signals when the sensitivity acquiring unit acquires the high sensitivity status.

### Aspect 1-5

In the aspect 1-4, the special communication signals include a reset signal and a non-reset signal, and

the sensor system assigns a sequential number code to the non-special communication signals in the chronological order of transmission and reception,

the sensor system resets the sequential number code to its initial value in response to the transmission and reception of the reset signal among the special communication signals, and

the sensor system does not reset the sequential number code to its initial value in response to the transmission and reception of the non-reset signal among the special communication signals.

### Aspect 1-6

In the aspect 1-4 or 1-5, the non-special communication signals include a detection result signal indicating the result of the detection operation by the sensor unit.

### Aspect 1-7

In any one of aspects 1-4 to 1-6, the sensor system is switchable between a first communication mode that enables bi-directional communication between the central unit and the sensor unit and a second communication mode that enables one-way communication from the sensor unit to the central unit,

the sensor system switches from the first communication mode to the second communication mode when the sensor unit receives a trigger signal from the central unit,

the special communication signals are transmitted and received in the first communication mode, and

the non-special communication signals are transmitted and received in the second communication mode.

### Aspect 1-8

In the aspect 1-7, the first communication mode is an instruction response mode in the DSI protocol, and

the second communication mode is a periodic data collection mode in the DSI protocol.

### Aspect 1-9

In the aspect 1-7 or 1-8, the sensor system switches from the first communication mode to the second communication mode when a mode change signal to change the communication mode from the first communication mode to the second communication mode, a detection start signal to start the detection operation in the sensor unit, or a detection condition setting signal to set conditions for the detection operation in the sensor unit, each of which is one of the special communication signals is transmitted and received.

### Aspect 1-10

In any one of the aspects 1-7 to 1-9, the sensor system, when received the special communication signals in the second communication mode, performs an operation corresponding to the special communication signals.

### Aspect 1-11

In any one of the aspects 1-1 to 1-10, the sensor unit is an object (B) detection sensor that receives a reflected wave of an exploratory wave from an object.

### Aspect 1-12

In aspects 1-11, the sensor unit is mounted to a vehicle (C) to detect objects around the vehicle.

### Aspect 2-1

A communication control method for controlling communication between a central unit (2) and a sensor unit (3) in a sensor system (1), the sensor system comprising the central unit as a master device and the sensor unit as a slave device, wherein the communication control method comprises:

acquiring a sensitivity status of the sensor unit during a detection operation in the sensor unit, the sensitivity status being defined as either a high sensitivity status or a low sensitivity status that is lower than the high sensitivity status; and

communicating special communication signals when the low sensitivity status is acquired, the special communication signals being communication signals that are noise sources in the detection operation.

### Aspect 2-2

In the case of aspect 2-1, the sensitivity status changes with the passage of time during the detection operation.

### Aspect 2-3

In the aspect 2-1 or 2-2, the special communication signals include a command signal sent from the central unit to the sensor unit and a response signal sent from the sensor unit to the central unit in response to the command signal.

### Aspect 2-4

In any one of the aspects 2-1 to 2-3, the communication control unit communicates non-special communication signals different from the special communication signals when the sensitivity acquiring unit acquires the high sensitivity status.

### Aspect 2-5

In the aspect 2-4, the special communication signals include a reset signal and a non-reset signal, and

the sensor system assigns a sequential number code to the non-special communication signals in the chronological order of transmission and reception,

the sensor system resets the sequential number code to its initial value in response to the transmission and reception of the reset signal among the special communication signals, and

the sensor system does not reset the sequential number code to its initial value in response to the transmission and reception of the non-reset signal among the special communication signals.

### Aspect 2-6

In the aspect 2-4 or 2-5, the non-special communication signals include a detection result signal indicating the result of the detection operation by the sensor unit.

### Aspect 2-7

In any one of aspects 2-4 to 2-6, the sensor system is switchable between a first communication mode that enables bi-directional communication between the central unit and the sensor unit and a second communication mode that enables one-way communication from the sensor unit to the central unit,

the sensor system switches from the first communication mode to the second communication mode when the sensor unit receives a trigger signal from the central unit,

the special communication signals are transmitted and received in the first communication mode, and

the non-special communication signals are transmitted and received in the second communication mode.

### Aspect 2-8

In the aspect 2-7, the first communication mode is an instruction response mode in the DSI protocol, and

the second communication mode is a periodic data collection mode in the DSI protocol.

### Aspect 2-9

In the aspect 2-7 or 2-8, the sensor system switches from the first communication mode to the second communication mode when a mode change signal to change the communication mode from the first communication mode to the second communication mode, a detection start signal to start the detection operation in the sensor unit, or a detection condition setting signal to set conditions for the detection operation in the sensor unit, each of which is one of the special communication signals is transmitted and received.

### Aspect 2-10

In any one of the aspects 2-7 to 2-9, the sensor system, when received the special communication signals in the second communication mode, performs an operation corresponding to the special communication signals.

### Aspect 2-11

In any one of the aspects 2-1 to 2-10, the sensor unit is an object (B) detection sensor that receives a reflected wave of an exploratory wave from an object.

### Aspect 2-12

In aspects 2-11, the sensor unit is mounted to a vehicle (C) to detect objects around the vehicle.

### Aspect 3-1

A communication control program to be executed by a communication control device (50) that controls communication between a central unit (2) and a sensor unit (3) in a sensor system (1), the sensor system comprising the central unit as a master device and the sensor unit as a slave device, wherein the communication control program causes the communication control device (50) to perform:

acquiring a sensitivity status of the sensor unit during a detection operation in the sensor unit, the sensitivity status being defined as either a high sensitivity status or a low sensitivity status that is lower than the high sensitivity status; and

communicating special communication signals when the low sensitivity status is acquired, the special communication signals being communication signals that are noise sources in the detection operation.

### Aspect 3-2

In the case of aspect 3-1, the sensitivity status changes with the passage of time during the detection operation.

### Aspect 3-3

In the aspect 3-1 or 3-2, the special communication signals include a command signal sent from the central unit to the sensor unit and a response signal sent from the sensor unit to the central unit in response to the command signal.

### Aspect 3-4

In any one of the aspects 3-1 to 3-3, the communication control unit communicates non-special communication signals different from the special communication signals when the sensitivity acquiring unit acquires the high sensitivity status.

### Aspect 3-5

In the aspect 3-4, the special communication signals include a reset signal and a non-reset signal, and

the sensor system assigns a sequential number code to the non-special communication signals in the chronological order of transmission and reception,

the sensor system resets the sequential number code to its initial value in response to the transmission and reception of the reset signal among the special communication signals, and

the sensor system does not reset the sequential number code to its initial value in response to the transmission and reception of the non-reset signal among the special communication signals.

### Aspect 3-6

In the aspect 3-4 or 3-5, the non-special communication signals include a detection result signal indicating the result of the detection operation by the sensor unit.

### Aspect 3-7

In any one of aspects 3-4 to-6, the sensor system is switchable between a first communication mode that enables bi-directional communication between the central unit and the sensor unit and a second communication mode that enables one-way communication from the sensor unit to the central unit,

the sensor system switches from the first communication mode to the second communication mode when the sensor unit receives a trigger signal from the central unit,

the special communication signals are transmitted and received in the first communication mode, and

the non-special communication signals are transmitted and received in the second communication mode.

### Aspect 3-8

In the aspect 3-7, the first communication mode is an instruction response mode in the DSI protocol, and

the second communication mode is a periodic data collection mode in the DSI protocol.

### Aspect 3-9

In the aspect 3-7 or 3-8, the sensor system switches from the first communication mode to the second communication mode when a mode change signal to change the communication mode from the first communication mode to the second communication mode, a detection start signal to start the detection operation in the sensor unit, or a detection condition setting signal to set conditions for the detection operation in the sensor unit, each of which is one of the special communication signals is transmitted and received.

### Aspect 3-10

In any one of the aspects 3-7 to 3-9, the sensor system, when received the special communication signals in the second communication mode, performs an operation corresponding to the special communication signals.

### Aspect 3-11

In any one of the aspects 3-1 to 3-10, the sensor unit is an object (B) detection sensor that receives a reflected wave of an exploratory wave from an object.

### Aspect 3-12

In aspects 3-11, the sensor unit is mounted to a vehicle (C) to detect objects around the vehicle.

What is claimed is:

1. A communication control device configured to control communication between a central unit and a sensor unit in a sensor system, the sensor system comprising the central unit as a master device and the sensor unit as a slave device, the communication control device comprising:
a sensitivity acquiring unit, that acquires a sensitivity status of the sensor unit during a detection operation in the sensor unit, the sensitivity status being defined as either a high sensitivity status or a low sensitivity status that is lower than the high sensitivity status; and
a communication control unit that communicates special communication signals when the sensitivity acquiring unit acquires the low sensitivity status, the special communication signals being communication signals that are noise sources in the detection operation.

2. The communication control device according to claim 1, wherein
the sensitivity status changes with the passage of time during the detection operation.

3. The communication control device according to claim 1, wherein
the special communication signals include a command signal sent from the central unit to the sensor unit and a response signal sent from the sensor unit to the central unit in response to the command signal.

4. The communication control device according to claim 1, wherein
the communication control unit communicates non-special communication signals different from the special communication signals when the sensitivity acquiring unit acquires the high sensitivity status.

5. The communication control device according to claim 4, wherein
the special communication signals include a reset signal and a non-reset signal, and
the sensor system assigns a sequential number code to the non-special communication signals in the chronological order of transmission and reception,
the sensor system resets the sequential number code to its initial value in response to the transmission and reception of the reset signal among the special communication signals, and
the sensor system does not reset the sequential number code to its initial value in response to the transmission and reception of the non-reset signal among the special communication signals.

6. The communication control device according to claim 4, wherein
the non-special communication signals include a detection result signal indicating the result of the detection operation by the sensor unit.

7. The communication control device according to claim 4, wherein
the sensor system is switchable between a first communication mode that enables bi-directional communication between the central unit and the sensor unit and a second communication mode that enables one-way communication from the sensor unit to the central unit,
the sensor system switches from the first communication mode to the second communication mode when the sensor unit receives a trigger signal from the central unit,
the special communication signals are transmitted and received in the first communication mode, and
the non-special communication signals are transmitted and received in the second communication mode.

8. The communication control device according to claim 7, wherein
the first communication mode is an instruction response mode in the DSI protocol, and
the second communication mode is a periodic data collection mode in the DSI protocol.

9. The communication control device according to claim 7, wherein
the sensor system switches from the first communication mode to the second communication mode when a mode change signal to change the communication mode from the first communication mode to the second communication mode, a detection start signal to start the detection operation in the sensor unit, or a detection condition setting signal to set conditions for the detection operation in the sensor unit, each of which is one of the special communication signals is transmitted and received.

10. The communication control device according to claim 7, wherein
the sensor system, when received the special communication signals in the second communication mode, performs an operation corresponding to the special communication signals.

11. The communication control device according to claim 1, wherein
wherein the sensor unit is an object detection sensor that receives a reflected wave of an exploratory wave from an object.

12. The communication control device according to claim 11, wherein
the sensor unit is mounted to a vehicle and detect the object existing around the vehicle.

13. A communication control method for controlling communication between a central unit and a sensor unit in a sensor system, the sensor system comprising the central unit as a master device and the sensor unit as a slave device, wherein the communication control method comprises:
acquiring a sensitivity status of the sensor unit during a detection operation in the sensor unit, the sensitivity status being defined as either a high sensitivity status or a low sensitivity status that is lower than the high sensitivity status; and
communicating special communication signals when the low sensitivity status is acquired, the special communication signals being communication signals that are noise sources in the detection operation.

14. A computer-readable non-transitory storage medium storing a communication control program to be executed by a communication control device that controls communication between a central unit and a sensor unit in a sensor system, the sensor system comprising the central unit as a master device and the sensor unit as a slave device, wherein the communication control program causes the communication control device to perform:
acquiring a sensitivity status of the sensor unit during a detection operation in the sensor unit, the sensitivity status being defined as either a high sensitivity status or a low sensitivity status that is lower than the high sensitivity status; and
communicating special communication signals when the low sensitivity status is acquired, the special communication signals being communication signals that are noise sources in the detection operation.
